(19) United States
(12) Patent Application Publication
(10) Pub. No.: US 2008/0063808 A1
(43) Pub. Date: Mar. 13, 2008

(54) Method for the Preparation of High-Efficient, Tuneable and Switchable Optical Elements Based on Polymer-Liquid Crystal Composites

(75) Inventors: Joachim Stumpe, Nauen (DE); Sergej Slussarenko, Kiev (UA); Oksana Sakhno, Berlin (DE)

Correspondence Address: GUDRUN E. HUCKETT DRAUDT, SCHUBERTSTR. 15A, WUPPERTAL, 42289, omitted

(73) Assignee: FRAUNHOFER-GESELLSCHAFT ZUR FORDERUNG DER ANGEWANDTEN FORSCHUNG E.V., MUNCHEN GERMANY (DE)

(21) Appl. No.: 11/571,426

(22) PCT Filed: Jun. 28, 2005
(86) PCT No.: PCT/EP05/06950

§ 371 Date: Oct. 1, 2007

(30) Foreign Application Priority Data
Jun. 29, 2004 (EP) 04 015 240.7

(51) Int. Cl. B05D 5/06; B05D 3/06

(52) U.S. Cl. 427/510

(57) ABSTRACT

A homogeneous isotropic mixture of photocurable monomers and/or oligomers, one or more liquid crystals or a liquid crystal mixture, and optionally a photoinitiator is provided that is homogeneous and optically clear within a temperature range of between 15 and 25° C. An optically transparent film of the homogenous isotropic mixture on a substrate or in a space between two substrates is prepared. The optically transparent film is irradiated with an inhomogeneous light field of actinic light such that areas of the film are irradiated while others are not. The intensity is sufficiently low that first areas solely, substantially or mainly composed of photocured polymer are formed, while the liquid crystals or liquid crystal mixture completely, substantially or mainly escapes into second areas that are not or substantially not irradiated. The substrates are removed depending on whether the rigid or flexible film is to be prepared alone or on a substrate.

The present invention relates generally to homogeneous and isotropic, non-scatterings films, made from mixtures comprising at least one photocurable monomer or oligomer in admixture with at least one liquid crystal or a liquid crystal mixture and preferably being arranged on a substrate or between two such substrates. Further the invention relates to an irradiation procedure using a non-homogeneous field of actinic light that transfers the initially homogeneous film into a film which is characterized by areas comprising at least mainly photocured polymer and areas comprising at least mainly liquid crystal or liquid crystal mixtures. Such films may have 1D, 2D or 3D diffraction structures, and may for example be used as transmission, reflection or slantwise gratings or other optical elements for a wide variety of purposes. The diffractive structures are characterized by low values of light scattering, high anisotropy, a high switching contrast, a fast electro-optical response and a wide tuneable spectral region.

It has been shown that transmission and reflection holographic elements based on polymer dispersed liquid crystal structures, so called PDLC or HPDLC, are attractive for the construction of low loss electro-optic switches more than 10 years ago. Polymer dispersed liquid crystal (LC) materials, the method of optical element fabrication and related devices aimed for use are described in a number of articles and patents. The HPDLC gratings are characterized as volume phase gratings. Typically, the HPDLC morphology includes isolated or interconnected droplets containing nematic or smectic liquid crystal material, embedded in a polymer matrix, the droplets being randomly distributed in the polymer matrix and also being without an initial orientation, but being sensitive to switching by the application of an electrical field. Usually, photocrosslinkable monomers, oligomers, or polymers are used for the fabrication of (H)PDLC systems. These systems are characterized by a scattering “off”-state and a non-scattering “on”-state, in which the symmetry axes of the LC droplets are homogeneously aligned by an electric field.

It has not only been discovered that numerous characteristics of a PDLC film can be altered by varying the size of the LC droplets within the film, but also that LC droplets size can be controlled by carefully selecting the environment in which the polymerization of the film takes place. It is well known from PDLC technology that LC droplets size increase with lower exposure intensities and decrease with greater exposure intensities. The threshold and operating voltages of the films for optical transmission can be increased by reducing the droplets size or decreased by increasing the droplets size; its contrast ratio and absolute transmittance, its optical response times are dependent from the droplets size as well. The temperature at which the polymerization takes place and the LC concentration can also be selected to determine the electro-optic properties of the film.

Holographic optical elements (HOE), switchable under the influences of electric or magnetic field or temperature find a wide range of application in different opto-electronic systems and telecommunication networks. Usually these HOE are based on the above described polymer dispersed liquid crystal materials.

For example, Stone et al. in Proc. SPIE 4112, 38-47 (2000) describe optical switches based on cascades of electrically switchable PDLC transmission gratings. Such gratings operate in the Bragg regime wherein an incoming optical beam is switched between the zero- and first-diffracted orders via an applied electric field.

Further, Sutherland et al. in U.S. Pat. No. 5,942,157 describe the formulation of PDLC materials and their application in the holographic preparation of electrically switchable diffractive and refractive devices. In this reference, a description of the switching mechanism of PDLC grating is provided, and the condition for optical transparency is described as requiring the polymer index of refraction to be equal to the ordinary refractive index of usual nematic liquid crystal mixtures.

Bunning et al. in Polymer 36(14), 2699-2708 (1995) describe the operation of HPDLC transmission gratings. As in the aforementioned document, a simple description is provided to describe the optically clear state of the gratings.

In U.S. Pat. No. 4,688,900, Doane et al. describe PDLC light modulating materials that can be switched from a substantially scattering state to a substantially clear state, either using the application of an electric field or thermally, by heating the PDLC materials. In U.S. Pat. No. 4,890,902, Doane et al. describe PDLC materials with selectable viewing angles. In particular, formulations are described which allow the preparation of PDLC films that can be switched to a clear state for a selected viewing angle, or a range of viewing angles. This is accomplished by selecting the polymer content of the PDLC according to the index of refraction.

In U.S. Pat. No. 5,096,282, Margerum et al. describe a method to form PDLC elements from mixtures consisting of LCs dissolved in monomers. During photopolymerization of such solutions, films having a dispersion of LC droplets therein form. Correlation between the LC droplets size and selected characteristics of the film are found. It was shown that by controlling the conditions of photopolymerization, the LC droplet size may be selected which corresponds to the desired film characteristics. Correlations are established between the LC droplets size, the resulting film's threshold and the operating voltages for optical transmission, contrast ratio, absolute transmittance and electro-optical response times.

In U.S. Pat. No. 6,115,152, Popovich at al. describe switchable holographic optical elements based on PDLC materials with controllable diffractive parameters. Different types of the initial mixture and possible methods to control the parameters of the final structures are shown.

Although HPDLC structures have outstanding properties, their use is restriced due to their light-scattering properties, high switching voltage and too large time-response.

R. Caputo et al. in Journal of Experimental and Theoretical Physics, 91 (6), 2000, pp. 1190-1197 describe use of a material consisting of a mixture of a nematic liquid crystal and a prepolymer for the formation of a grating of submicron nematic layers by photopolymerization. Under the undispensible condition that the mixture was heated during irradiation and was subsequently cooled, a grating of oriented layers of a nematic liquid crystal, separated by isotropic polymeric walls, was obtained.

According to the teachings of this document as well as to later publications of the group of R. Caputo, namely PCT/IB2004/051174 and Optics Letters, Vol 29 (11), pp. 1261-1263, 2004, a specific temperature regimen is required to obtain the grating of alternating polymer and pure nematic material, instead of HPDLC gratings. Independent of the optical characteristics of the starting mixture, the temperature during irradiation must at least be as high as to obtain and to maintain an isotropic condition of the mixture, and to prevent an I-N transition during irradiation.

It is a time consuming measure to observe the specific temperature regimen as detailed in the papers of Caputo et al. Moreover, this method is restricted to suitable substrates which are not adversely affected by elevated or high temperatures. The gratings obtained therewith show switching times and diffraction efficiencies which are often not satisfying.

It is a problem of the present invention to overcome this disadvantage and to provide a superior method for the preparation of an optical element, for example a transmission or reflection or slantwise grating or having any other desirable and artificially controlled structure for any optical purpose, comprising an inhomogeneous distribution of polymer areas and optically clear liquid crystal areas, which is essentially or substantially free of light scattering and which exhibits strong anisotropy, and high diffraction efficiency, and therefore exhibiting a very short time-response and a superior switching contrast.

Surprisingly, the present inventors found that starting from a composite material having specific properties and using specific processing conditions, optical films can be created which can be used as diffractive optical elements (or holographic optical elements, HOE), which combine all the properties mentioned above and which exhibit superior effects. Th elements normally have the shape of a film on one or between two substrates and are characterized by a distribution of areas of different chemical and physical properties within the film, i.e. they do not show a droplet-like morphology of the liquid crystal areas as outlined above but contain separate, switchable areas or domains of aligned LC “frozen” into a crosslinked photopolymer matrix which is transparent or light transmitting for actinic light. These domains or areas may either extend from one surface of the film to the other, or LC areas and crosslinked photopolymer matrix may constitute alternating layers which extend along the plane of the film. In another variant, LC areas are completely surrounded by the crosslinked photopolymer matrix. This variant differs from the known, stochastic droplet structures of PDLCs in that the areas are located within the polymer in a well defined, ordered and/or periodical structure wherein the LC areas are optically clear, even before any voltage or other switching measure has been applied thereto or therethrough. This type of structures is characterized by much lower values or even the absence of light-scattering properties, transparency of the films obtained before, during and after illumination steps, strong anisotropy after the holographic or other exposure preparation step and higher electro-optical parameters of the final optical elements than earlier presented structures.

The films, disposed on a substrate or contained within the narrow space between two substrates, may be designated as POLIPHEM films (POlymer Liquid Crystal Polymer Holograms Electrically Managable). These structures may serve as electrically switchable and tuneable optical elements on the basis of micro-patterned POLIPHEM films.

The inventors found that such films may be obtained using irradiation conditions under ambient (normal) room temperature, which is usually in the range of 20-25° C., but may be even lower. The mixture they used as material for the film is an initially (i.e. normally at room temperature) homogenous and optically isotropic mixture of photocurable monomers and/or oligomers and liquid crystals or a liquid crystal mixture (subsequently sometimes designated as LC or LCs), optionally in admixture with additional components and/or in the presence of a photoinitiator, as far as required or desired, From this mixture, a film is initially formed between two substrates or on a substrate, the film being likewise homogeneous and optically isotropic. Due to its homogeneity, the mixture, and therefore also the film, is non-scattering. A phase separation is then obtained under the irradiation of a pattern of bright(er) and dark(er) areas of light, preferably performed as a one-step photopolymerization, without the necessity to increase the temperature above environmental conditions. By this illumination, periodic or otherwise ordered structures consisting of polymer- and LC-rich regions with a separate, aligned mono-domain morphology of the LC can be obtained. The phase separation is usually a complete one, and only in rare cases, some liquid crystal may remain entrapped in the polymer structure, while some monomers or oligomers, slightly polymerized or (further) oligomerized, may be present in the LC rich regions.

These POLIPHEM films differ from prior known holographic PDLC structures by the absence of light scattering, by a very strong anisotropy due to areas comprising or consisting of aligned LC and by a decreased time response. POLIPHEMS may operate as optical elements, for example as transmission or reflection diffraction volume gratings which can be switched between the diffractive and non-diffractive state by the application of an electric, electromagnetic or a magnetic field. Therefore, these structures may be used as optical switches. POLIPHEM based Bragg reflection gratings are tuneable which means that their reflection spectral band may be shifted within the wavelength scale upon application of an electric, electromagnetic or magnetic field. The morphology of the structure can be controlled by selecting a proper relation between the amount of monomers/oligomers and liquid crystals or a liquid crystal mixture, respectively, depending from the nature of the selected components, as known by a chemist or other skilled artisan. Moreover, the exposure intensity, exposure temperature, exposure wavelength and/or concentration of photoinitiator can be properly adapted, depending on the type of polymer and/or photoinitiator and the desired efficiency of the phase separation.

Thus, the said POLIPHEM films comprise first areas being composed of solely, substantially or mainly photocured polymer and second areas being composed of solely, substantially or mainly liquid crystals or a liquid crystal mixture. In contrast to the known (H)PDLC structures, it is a specific feature of the said films or optical elements that the said areas are either arranged in such a way that the first and second areas alternate in at least a first plane, while the composition of the film is substantially invariable in a direction which is angular to the said first plane, or that the said areas are located in an artificial, ordered, preferably periodic pattern and that the LC areas are optically clear and non-scattering, even in case they have never undergone an initial electrical, electromagnetic or magnetic switching. Such films and optical elements have a low value of light scattering, a high switching contrast, a short response time and widely tunable spectral regions.

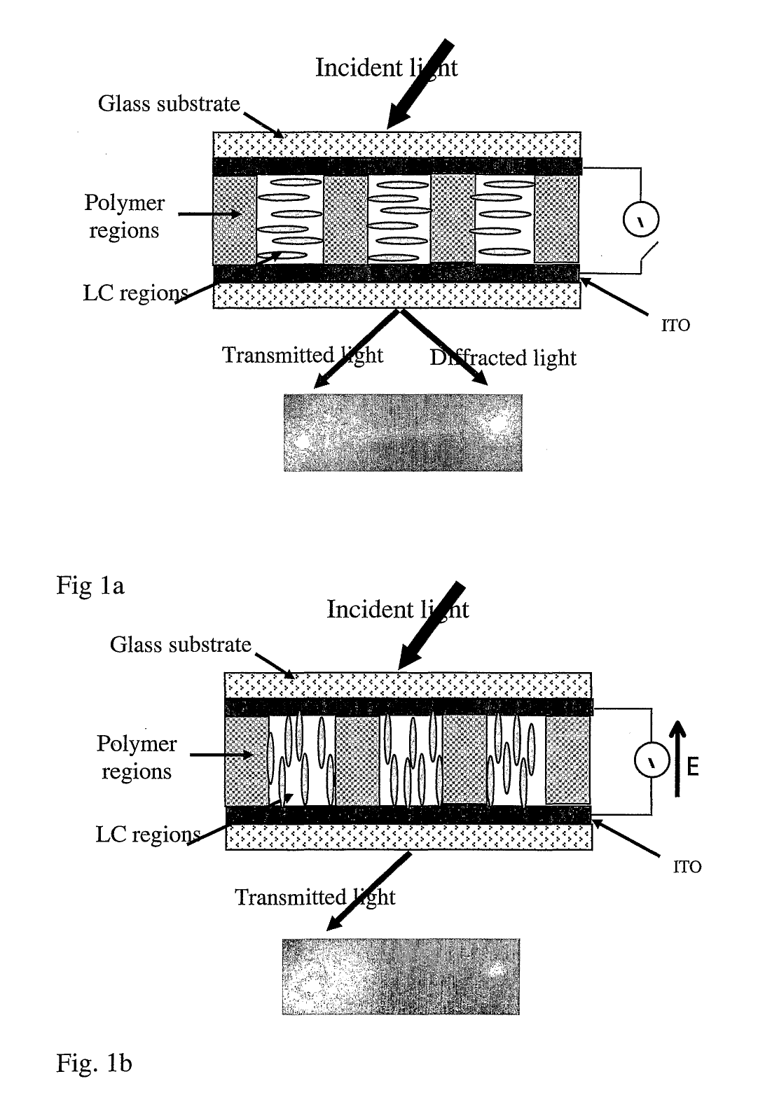

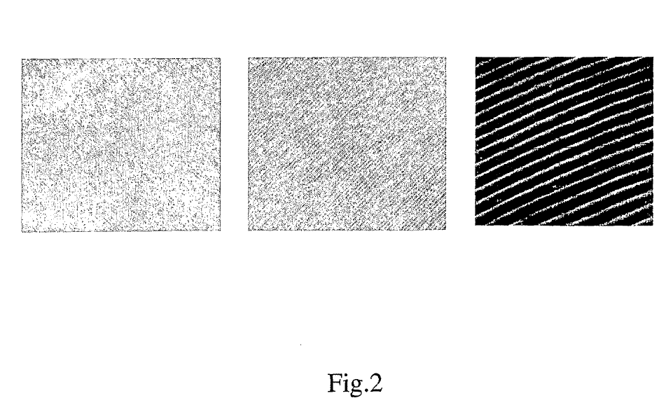

If the first and second areas are arranged such that they alternate in at least a first plane, but not in a second plane angular to said first plane, they may form periodically arranged 1D and preferably 2D structures wherein areas the composition of which is invariable extend either from one surface of the film to the opposite surface, or wherein the film consists of layers the composition of which is invariable and which extend along the film plane. In the first case, the invariably extending structures may be, but are not necessarily, in a plane perpendicular to the film plane, as depicted in the schemes of FIG. 1, or they may be tilted or slanted. They may be arranged in straight or curved fringes, stripes or lines, as shown in FIG. 2, or they may be completely surrounded by the respective other area, i.e. in a rod-like manner. Such 1D or 2D films may be used e.g. as transmission gratings. In case the invariable areas are located in the form of alternating layers extending along or substantially along the film plane, the films may be used e.g. as reflection gratings. In any of the mentioned cases, such a film structure may be obtained by irradiation of the film with a non-homogeneous field of actinic light producing a respective pattern of bright and dark areas within the film which may e.g. be holographic irradiation, as detailed below, or irradiating the film with polarized light, using a mask (so called amplitude mask). More sophisticated diffractive structures of the said polymer regions and LC regions can differ from a lined shape (such as bead-like or other 3D structure), and these may be fabricated under application of more complicated configurations of spatially modulated light field using 3 or even more beams. In all cases the initial film should fix adequately the incident inhomogeneous light fields.

The concrete pattern selected for a film of the invention will depend on the intended purpose in using the film as or within an optical element.

POLIPHEM films according to the present invention thus relate to a specific class of mixed polymer-liquid crystal composite materials in which two phases separate spontaneously upon photo-induced polymerization. The invention aims on techniques for the creation of holographic polymer-LC periodic structures having new and useful properties. Holographic diffraction gratings prepared according to the present invention can be employed in the Bragg or in the Raman-Nath regimes. The operating of the grating in a proper regime is determined by the ratio of period and thickness of the structure. In the Bragg regime, only two diffraction orders (0 and −1) are observed and angular and spectral parameters of both light and gratings fulfil the Bragg condition. Diffraction efficiency of Bragg gratings can reach up to 100%, and those gratings have spectral and angular dependence of the diffraction efficiency. In the Raman-Nath regime, a multiplicity of diffractive orders exists. Diffraction efficiency does not exceed 34% for sinus distribution of the refractive index and the diffraction is described by the general diffraction question. (Optical Holography R. J. Colier, C. B. Burckhardt, L. Y. Lin, 1971, Acad. Press, N.Y. London, 1973, 686 p.) POLIPHEM of this invention exhibit extremely low light scattering losses, high refractive index modulation, switching times in the microsecond scale, and a high contrast between “off” and “on” states.

As outlined above, polymer-LC diffractive and other structures are provided by this invention, consisting or comprising of alternating regions of mainly, almost or completely pure polymer and mainly, almost or completely pure LC or liquid crystal mixture. The LC or the LC mixtures are embedded in a photocrosslinked polymer network, but not in the form of droplets as in the aforementioned (H)PLDC structures, but extending in well defined structures as outlined above. The almost pure LCs areas, e.g. lines or “fringes” aligned between the polymer fringes can be easily switched by an electrical, electromagnetic or magnetic field. The orientation and form of these regions is dependent on the selected type of optical element (e.g. intended for transmission or reflection or both) and on the dimension of the structure (1D, 2D or 3D).

Thus, low-scattering diffraction structures are provided having a strong anisotropy and short switching time when subjected to an electric, electromagnetic or magnetic field, the high switching contrast being obtained by using proper irradiation conditions as outlined below to ensure a full or almost or at least substantially full phase separation of the initial mixture. Evidence of the existence of the mentioned structure formation may be obtained by observation of the specific form (two stages) of the kinetic curve of the holographic recording, high final diffraction efficiency (up to 99%), very low light-scattering and strong anisotropy (determined by oriented LC in LC-rich regions) of the final structure obtained by the irradiation step.

If the films of the present invention are used as volume diffraction gratings, they can be used as or in a multiplicity of optical devices. Examples are beam splitters, beam deflectors, dispersion elements, narrow-band reflectors or volume holographic diffusers. They can be further used as switchable beam-steering devices for free-space optical coupling, tuneable spectral filters and, especially, for waveguide systems. In order to be useful for telecommunications and other applications, it is desirable that the switchable gratings operate in the Bragg regime and can be switched between diffracting and non-diffracting states (“off-state” and “on-state”) via an applied electric (or electromagnetic or magnetic) field or via heating. Further, it is desirable that the gratings provide high contrast, low loss, low operating voltage and short response time.

For a better understanding of the present invention, reference is made to the accompanying figures, wherein:

FIG. 1a,b is a schematic representation of POLIPHEM transmission grating after the holographic recording without and with an applied electrical field;

FIG. 2 shows a POLIPHEM grating a) Λ=0.9 μm and b) Λ=1.2 μm and c) part of a Fresnel lens based on POLIPHEM (with a distance between neighbour areas near 6 μm) showing the lines or “fringes” of the structures between crossed polarizers;

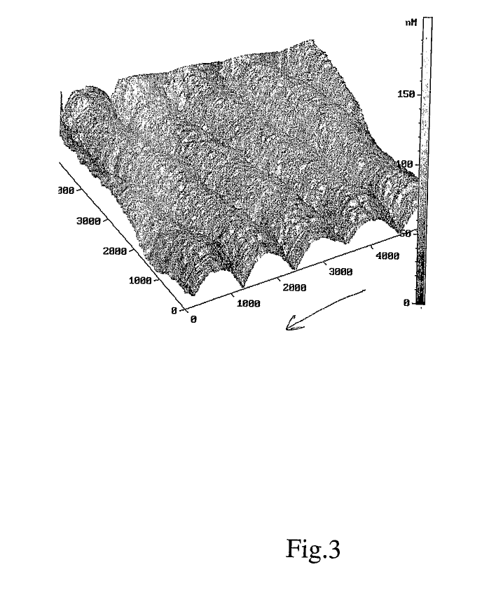

FIG. 3 is an atomic force microscopy picture of POLIPHEM structure after the removal of the upper substrate (Λ=1.2 μm);

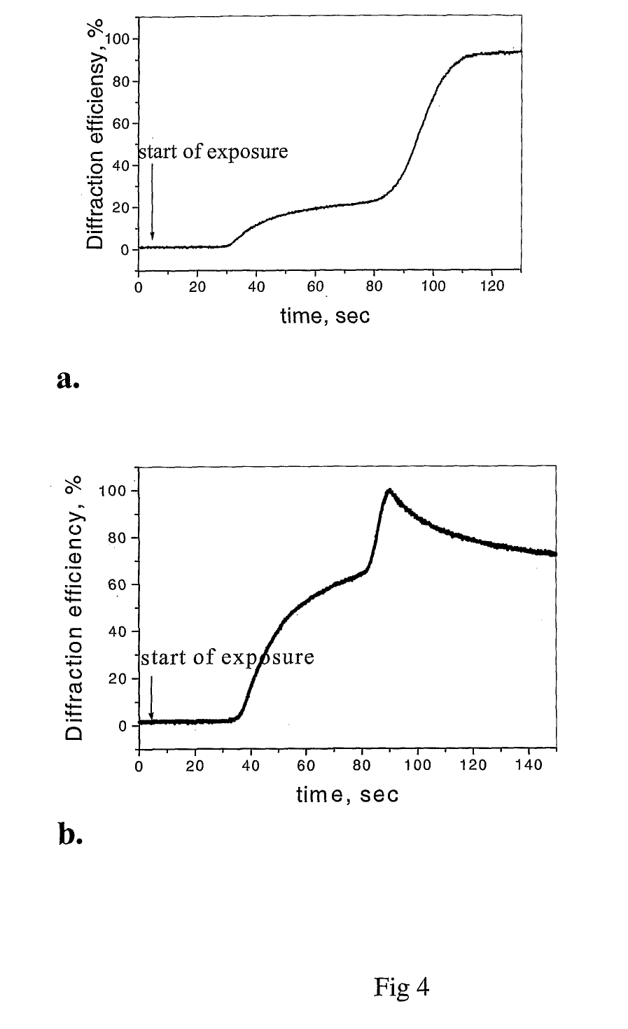

FIG. 4 shows kinetic curves of the holographic recording of POLIPHEM gratings with different recording intensities: a) I=30 mW/cm², b) 80 mW/cm²

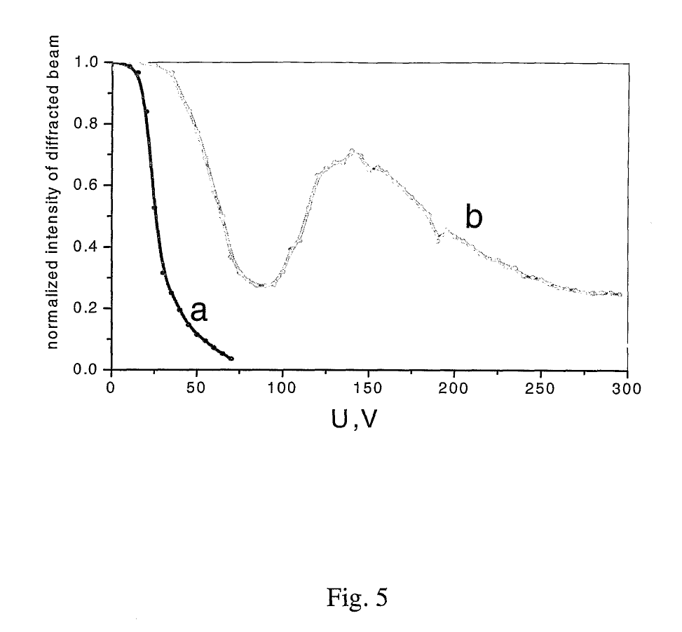

FIG. 5 illustrates the intensity of the diffracted beam via the applied voltage: a) transmission grating Λ=0.9 μm, d=12 μm (without over-modulation), b) transmission grating Λ=0.9 μm, d=12 μm (with over-modulation)

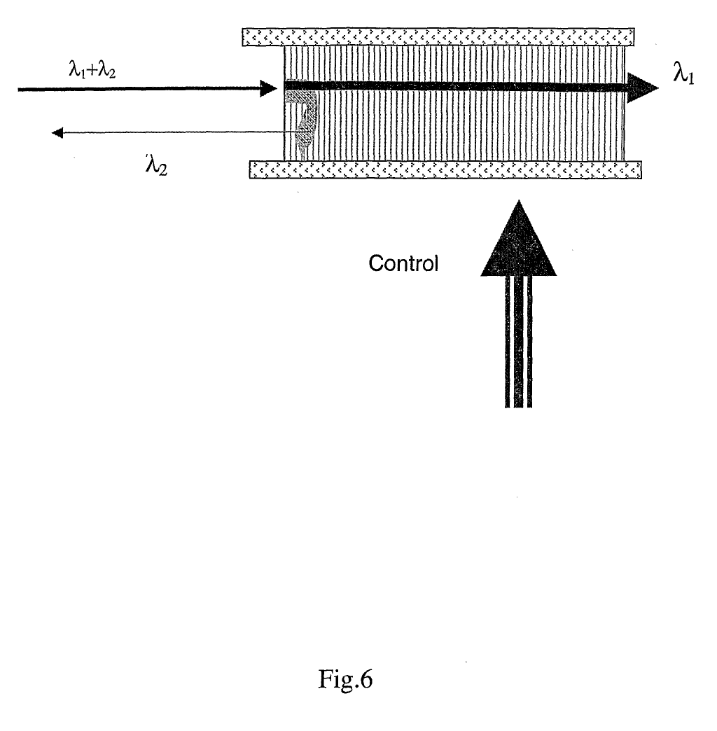

FIG. 6 is a schematic representation of a POLIPHEM film functioning as a tunable spectral filter.

As outlined above, the films of the present invention are obtained by forming a homogeneous, optically isotropic film on a substrate or between two substrates, the film being prepared from a homogeneous and isotropic, photocurable mixture, containing or consisting of a photopolymerizable component (composed of one or more monomers or/and oligomers), photoinitiator, if required or desired, and liquid crystal (LC) molecules or a LC mixture, optionally in admixture with additional components. The initial mixture should be selected such that an optically clear, non-scattering isotropic film of good quality can be formed which contains a relatively high amount of LC. Homogeneity of the initial mixture should be present at least in a temperature range of about 15-25° C. The same applies for the requirement that the film is optically isotropic.

In order to obtain such a homogeneous, isotropic mixture, the two major components of the photocurable mixture, the photopolymerizable component and the liquid crystal component, should be completely miscible when provided at the above mentioned temperature range of about 15-25° C. and will normally be combined in the said temperature range. This means that the proportion of the photocurable monomers and/or oligomers will be selected such that they “dilute” the LC component in such a way that the properties of anisotropic LC alignment are suppressed. In specific, but exceptional cases, mixing may take place above the said temperature, in case no phase separation will occur upon cooling to the above mentioned temperature. It is preferred that the mixture contains the photocurable monomer(s)/oligomer(s) and the liquid crystal(s) in high, substantial amounts.

It is moreover preferred that the ratio of the components is chosen such that the liquid crystal component is not far from the isotropic-non-isotropic phase transition, e.g. that already small loss of energy or changes of chemistry would re-establish the (preferably nematic, but also possibly other, for example smectic or cholesteric) alignment of the LCs and would transfer the mixture into an anisotropic state .

In principle, monomers and/or oligomers useful for the photopolymerizable component can be selected without limitation, as long as the monomer(s)/oligomer(s) is/are photopolymerizable and its mixture with the LC or LC mixture will be homogeneous and isotropic. Therefore, the said monomers and/or oligomers should of course be themselves isotropic. It is preferred to use relatively polar educts, in order to provide surface forces within the mixture that are just too low and just not sufficient to provoke a phase separation of the mixture with the liquid crystals. However, this is not a mandatory measure since miscibility with the LC or LC mixture may be properly adapted with the aid of additives, e.g. surfactants or the like, as known in the art. The monomers and/or oligomers can be (and will be in most cases) pure organic molecules, but in some cases, they may instead or in addition comprise “hybrid” inorganic-organic molecules, e.g. organically modified silanes.

In one specific and important embodiment of the invention, the monomer(s) or oligomer(s) used for the present invention will reach their gelation point under polymerization only after at least about 30% thereof have been reacted, preferably only after about 50% monomer-polymer conversion degree, and more preferably, only after about 70% to 80% monomer-polymer conversion degree, the percentage being on a molar basis. The reason for this measure is that an early gel point will negatively affect or even prohibit complete phase separation: If the forming polymers attain at their gel point, remaining liquid crystal molecules can no longer escape from the forming network, but remain entrapped therein. The inventors found that if the gel point is only reached after the majority of the monomers or polymers has reacted, the liquid crystal molecules will have sufficient time to escape from the forming polymer network and to diffuse into the dark regions which are free from said network, i.e. a complete separation will take place, without the necessity to raise the temperature of the mixture above environmental temperature. Therefore, use of organic, polymerizable monomers or oligomers having a “late” gel point will result in a better separation and therefore in improved and superior optical properties of the resulting gratings, for example in better switching times.

On the other hand, it should be kept in mind that the method of the present invention will be most effective if photocrosslinking is performed such that a dense network is obtained. The dense network formation increases the liquid compound separation, resulting in areas enriched with this component (LC) and, finally after nematic ordering of LCs, macroscopically aligned liquid crystalline phase areas and between said areas polymer network areas are formed in which the reactive monomers are enriched and polymerized. It is to be noted that the said process will take place under environmental temperature conditions.

Under consideration of the above, It is preferred to use compounds having at least one C═C double bond. The said or at least one of the C═C double bonds may be part of a so called Michael system, e.g. containing the fragment C═C—C═O. Alternatively or in addition, so called thiol-ene combinations wherein a thiol compound is added to a compound having a C═C double bond, and/or compounds having epoxy groups may be used. The said combinations are preferred due to the fact that the gel point is only reached after a substantial amount thereof has been reacted. More preferably, a mixture of monomers and/or oligomers having a different number of double bonds is used, even more preferably together with one or more thiol compounds. One example is the combination of penta-acrylates with di- or tri-acrylate in order to optimize both the functionality and viscosity of the pre-polymer material. In a specifically preferred embodiment, a mixture of approximately 1:4 or 1:2 of di- to penta-acrylate is used in order to assist homogeneous mixing. With such a mixture, optically transparent recording films of desired thickness, e.g. 6-20 μm, can easily be prepared.

As an example, suitable monomers and oligomers may be selected from the group comprising acrylates and methacrylates, such as diethylene glycol diacrylate, diethylene glycol dimethacrylate, triethylene glycol diacrylate, triethylene glycol dimethacrylate, trimethylol propane, diallyl ether, trimethylolpropane triacrylate, pentaerythritol triacrylate, pentaerithritol tetracrylate, pentaerythol pentacrylate, and dipentaerythrytol hydroxy pentacrylate. Bifunctional or multifunctional acrylates as the photopolymerizable component have the advantage that they typically exhibit a high compatibility with low-molecular liquid crystal components which allows to use a high LC concentration and to prepare recording films having a high optical quality.

As an example of non-acrylate monomers, pentaerythritol tetrakis (3-mercapto) propionate can be mentioned, which may be added to a C═C-containing compound, e.g. vinyl compounds. For example, photocurable components normally used as adhesives and containing different thiol-ene monomers and oligomers in the combination with acrylate compounds, e.g. Norland NOAO-61,65,68,81, can be used. The proper selection will result in such a mixture which is initially homogenous, but which under the polymerization conditions will undergo a process of phase separation, separating the the liquid crystal component from the growing polymer network, by which the morphology of the resulting structures is attained. Use of thiol-ene polymerizable components are favorable, due to their specific photopolymerization kinetics. This is because the combination of step-growth and free-radical reaction between multifunctional aliphatic thiols and vinyl monomers containing “ene” groups result in a late “gelation—point”. Moreover, most of the double bonds are consumed while the precursor is still liquid. Due to these features, it is possible to compose the photopolymerizable mixture exclusively, essentially or substantially from the photopolymerizable component and the liquid crystal component only, without the addition of auxiliary components, e.g. surfactants, and to arrive at a two-phase structure as detailed above, upon proper irradiation as described.

The second component of POLIPHEM material is a liquid crystal (LC) component. This component allows the electro-optical response of the resulting structures. Suitable LCs, used in practice of the present invention may include any types of LC. Selection of a proper LC or LC mixture for the photocurable mixture is not critical. This means that e.g. any of nematic, cholesteric or smectic molecules can be used, wherein the liquid crystals may be used alone or in admixture with other components as known from the art. The LC mixtures may additionally contain dopants in order to obtain a further functionalisation of LCs and thus, resulting in additional desired properties of the final device. Such dopants may be e.g. dye molecules or photochromic molecules.

The concentration of LC utilized should be selected such that on one hand, it is sufficiently high to allow a significant phase separation of the mixture upon irradiation, but should not exceed the amount beyond which PDLC structures might be formed which, as outlined above, are opaque and hazy. If the liquid crystal component is present in an amount below 20% by weight of the prepolymer mixture or polymerizable mixture, a rather weak difference of the refractive indices in the first and second areas will occur upon irradiation at room temperature, even if a full phase separation occurs, and consequently, diffraction efficiency would be low. On the other hand, if the LC component is present in an amount of more than 45% by weight, the product will mostly become highly scattering, and its diffraction efficiency and transmittance decreases. Thus, it is preferred to incorporate the LC component in a proportion of 25 to 45% by weight, in relation to the weight of the prepolymer mixture, and more preferably in a proportion of approximately 35-40% by weight. Such mixtures typically result in a film or coating which shows high diffraction efficiency, optical clarity and good electro-optical parameters. In addition, the mixture should preferably be selected such that the addition of not more than about 10% by weight, preferably not more than 5% by weight, more preferably not more than about 2% by weight an most preferred not more than about 0.4 to 0.7% by weight of the liquid crystal component to the mixture as chosen for the invention would result in a opaque or scattering mixture wherein the liquid crystal component would arrange itself in its “liquid crystal” order. By this selection of the LC ratio, it is made sure that the liquid crystals or liquid crystal mixture are/is disturbed in the mixture by the presence of the other component(s) and therefore do/does not exhibit their “normal”, e.g. nematic behaviour, but that the liquid crystals in the mixture could be brought into said “normal” behaviour already upon small losses of energy or by slight amendments in the chemical conditions. In other words, the concentration of LC should be selected in order to obtain such conditions upon which the forces for a phase separation of the mixture prior to irradiation should be only slightly higher than the attraction forces.

Addition of a surfactant (e.g. octanoic acid, heptanoic acid, hexanoic acid and the like) has an effect on the miscibility of the components (i.e. increases miscibility), increases the optical performances of the film, inter alia the switching time, and decreases the switching voltage. For example, Fluorad RTM FC-430 or Fluorad RTM FC-431 can be used in a weight concentration 0.2-5%, related to the weight of the polymerizable mixture.

As far as the polymerizable mixture requires a photoinitator for starting polymerization, the sensitivity of the prepolymer materials to illumination light is determined by the presence of such a photoinitiator and its concentration. Type and concentration of photoinitiator will be selected considering the irradiation wavelength required or desired and the compounds to be polymerized. In this context, the expression “photopolymerizable” is used to include not only the possibility of polyaddition, but also of polycondensation, and the expression “photopolymerizable compound” or “photopolymerizable mixtures” shall encompass any compound having one or more functional groups which participate in the curing of the polymer matrix. Photoinitiators are activated by irradiation with actinic light and free active radical formation. Free radicals created usually start the polymerization process.

Conveniently, photoinitiators to be employed, if necessary or desired, are commercially obtainable substances. For example, Irgacurep®184, Irgacure®1700, Irgacure®500, Irgacure®369, Irgacure®1117 (Ciba—Geily), Michlers ketone, (1-hydroxycyclohexyl) phenyl ketone, benzophenone or similar derivatives can be used for UV irradiation recording. For blue-green and red light sources the known photoinitiator systems like Irgacure 784, dye rose bengal ester, rose Bengal sodium salt, campharphinone, methylene blue and like with electron donor (co-initiators) can be used. Coinitiators can be employed in order to control the rate of curing in the free radical polymerization of the original prepolymer. Suitable coinitiators are N-phenylglicine, triethylamine, thriethanolamine and like.

The Norland Products, NOA® adhesives, employed in the below examples, include their own photoinitiator (for UV region of spectra). Other initiators can also be used, such as benzophenone, 2,2-diethoxyacetophenone (DEAP), benzoin, benzil or Irgacure®1700, Irgacure®369 as additives to Norland NOA®-61,65,68,81 to increase the photosensitivity in UV region of the spectrum and to complete a phase separation process between polymer and LC components.

It has been found that the best results in respect to the quality of the final devices, their diffraction efficiency and their electrooptical behaviour were achieved using an initiator amount of 0.5-2% by weight and a coinitiator in an amount of up to 2-3% by weight.

As mentioned earlier, it is necessary that the mixture is homogeneous and isotropic at the processing temperature which is environmental temperature. A skilled person is able to select the components accordingly.

In many cases, mixing the two major components will result in an isotropic, homogeneous mixture, without any additional measure. This is for example the case if the photocurable monomers and/or oligomers are selected such and in such a relation that the anisotropy of the “liquid crystals” is slightly (but preferably only slightly, see above) disturbed and consequently, they do not behave as liquid crystals in the said mixture, and instead, their “LC” properties (alignment) is suppressed. Photocurable monomers or oligomers for this purpose are for example (e.g. for the example of nematic LCs) molecules having a globular or more or less coiled or bulky shape, and which at least do not have the rod-like structures of the liquid crystal molecules. Acrylates, and more preferably pentaacrylates are an example for such molecules, while the skilled artisan is aware of a multiplicity of others. On the other hand, it should be kept in mind that the properties of the photopolymerizable monomer/oligomer component and the LC(s) for a specific mixture should be preferably selected such that they show physicochemical similarity (e.g. polarity) in such a way that they function as a “good” solvent for each other. Such a requirement may be met by a proper selection of physical interaction of the molecules, e.g. attraction or repulsion forces (like ionic or Van-der-Waals forces, coulomb interactions, phase separation/phase segregation tendency, specific inermolecular interactions, ratio of polarities, . . . ). Alternatively or in addition, other measures may be taken in order to disturb the anisotropy of the LCs, e.g. photochemical means (e.g. irradiation) by which non-mesogenic isomers are reversibly generated for a limited time period, a proper selection of the temperature profile at the time of mixing the components and subsequent cooling, application of a magnetic field, or the addition of photochromic additives. Of course, that part of the molecule mixture which upon irradiation will constitute the liquid crystal areas of the film to be used as an optical element must then, again, exhibit “normal” anisotropy of liquid crystals, i.e. must have at least nematic (or other LC) properties.

In short, the skilled artisan will preferably select a combination of photocurable monomer(s)/oligomer(s) and LC(s) having similarities in those physicochemical properties which are relevant for attraction and miscibility, but being of different shape, wherein specifically the monomer(s)/oligomer(s) do not have the rod-like (in the case of nematic LCs) or disk-like (in the case of cholesteric) structure of the LC component.

All components are mixed together by suitable means (e.g. ulta-sonification). The thus obtained starting mixture is a homogeneous, in general optically transparent blend.

According to the present invention, the said mixture is brought into the shape of a film, either on a substrate or between two such substrates. The above described first and second areas are preferably formed in this film by irradiation under conditions which are selected in respect of the properties (and especially the reactivity) of the components of the mixture and their concentration. The aim of irradiation is to obtain a high network density and to stimulate a spatially periodical separation of LCs from a forming network.

In most cases, a relatively low exposure intensity will be used, the specific value of which will be selected dependent on the materials employed (mainly reactivity of the polymerizable component and its concentration or, rather, concentration of the polymerizable groups), as known to a skilled artisan, but of course is also interdependent on other factors, e.g. the kind and concentration of polymerization initiator and time of irradiation. The intensity is selected such that it will ensure a relatively low photopolymerization rate of the local monomers/oligomers present in the bright regions of the inhomogeneous light field. On the other hand, a dense polymer network should be obtained. As a consequence, the LC molecules and also possibly a minor part of polymerizable material, e.g. monomers or smaller oligomers, may diffuse from the bright regions to the dark regions which-results in a more or less complete phase separation of the initial mixture. The driving force for the formation of a periodic volume structure into initially liquid monomer-diluent (LCs) is believed, according to literature, to be based on built-in concentration gradient of monomer inside the initial film during the local photopolymerization process, which induces the diffusion of monomer to the bright region on the illumination pattern. Subsequently, diluent (or the LC) molecules counterdiffuse to the dark region of the pattern. Finally, two-phase line-like structure is formed.

Local polymerization rate is related to local light intensity (relative contrast of the interference (illumination) pattern), functionality of oligomer and photoinitiator type and concentration and others. Upon photopolymerization of the crosslinkable polymerizable material, a shrinkage of this material occurs, driving out smaller molecules in sponge like manner. Without being wanted to be bound to any theory, inventors believe that photopolymerization can best be obtained, according to the present invention, by preferably providing conditions which allow at least one of, and preferably a combination of a low polymerization rate, a “late” gelation point and provide a dense network.

The phase separation tendency is connected with compatibility of the component, their polarity ratio, specific interfacial interaction between molecules, temperature. Although the process of periodic volume structures (holograms) formation in monomer-liquid solvent (LCs) mixture is quite complex and need a careful consideration of chemical, thermodynamical, physical processes taking account and effecting on this process, inventors believe that best results can be obtained using the measures outlined above.

The appropriate choice of all components of the photopolymerizable mixture (photopolymerizable monomers, LC, initiator system and additives, if required) and adjustment of their concentration, as described above, ensure high optical and electrical switching parameters of the final structures. The first component (photopolymerizable monomer(s) and/or oligomer(s)) will supply the formation of a closely cross-linked network under irradiation which tends to force the second phase material, the LC component, to anisotropically diffuse out of the forming or formed polymeric areas (which build up in the bright, irradiated parts) into well-definable regions comprising merely, substantially or mainly LC molecules or a LC mixture. These regions may be well aligned (after ordering of LCs) into “line-like” areas. The photoinitiator system and the intensity and wavelength of the actinic light, and parameters of different steps of the polymerisation process (initiation, propagation and termination) should control the rate of polymerization, phase separation of components and the final two-component structure of POLIPHEM such that the rate of polymerization is preferably low, in order to allow a full phase separation as detailed above.

The resulting structure may be a POLIPHEM film contained within a cell comprising of two substrates preferably made of glass or plastic and coated with a conducting film (FIG. 1.), e.g. of a transparent indium-tin-oxide (ITO) conducting film as known from LCD devices, which facilitates the application of an electric field across the film. At least one of the substrates should be transparent to allow transmission of the applied light. Spherical or cylindrical spacers are used to separate the glass substrates and maintain the cell thickness d throughout the cell. Usually the thickness of the cell varies from about 5 up to about 50 μm. To obtain such a film, the liquid or viscous starting mixture is usually filled into the space between the said substrates.

Thus, POLIPHEM structures (preferably holographic transmission and reflection (non-slanted or slantwise) volume diffraction gratings) form during exposure of the originally homogeneous, preferably isotropical film under conditions by which first areas of the film are irradiated, while second ones are not or substantially not. This irradiation may be performed e.g. either by using a masks or by holographic recording, i.e. a recording of light using 2 or more monochromatic beams of actinic light in such a way that the light intereferes in the film plane. Typical “holographic” recording set-ups can be used to fabricate POLIPHEM structures. After spatial filtering, expanding and division of an initial laser beam on the beam-splitter, the resulting beams are intersected and form the interference picture that is recorded in the volume of the reactive layer (or, in other words, by which the reactive layer is irradiated). The recording field, consisting of the constructive (bright) and destructive (dark) interference regions within the expanded beams, establishes a periodic intensity profile through the thickness or volume of the film. Recording beams penetrate into the film from the same side of the film if transmission gratings are to be fabricated, and from different sides if reflection gratings shall be formed (symmetrically—in the case of nonslanted gratings and asymetrically—in the case of slantwise gratings). Such non-homogeneous illumination initiates a locally fast polymerization of photopolymerizable monomers and/or oligomers in the bright regions of the mask or interference field which, however, is not too fast to allow escape of the smaller monomers so that the brighter regions are completely, almost or mainly depleted from LC molecules. The monomer concentration gradient causes a diffusion of photopolymerizable units from the dark to the bright regions, due to shrinkage effects which develop a sort of drawing force, while and the the second component, such as nematic or other liquid crystals, are forced into the opposite direction, due to phase separation tendencies and photopolymerization forces which act like a sponge, pushing small molecules out of the growing polymer network. Therefore, the smaller molecules, i.e. liquid crystal molecules, but possibly also smaller unreacted monomers, diffuse into the dark regions of the interference field. Thus, alternating well-defined regions of more or less or completely pure LC or liquid crystal mixture, separated by well-defined, more or less or completely pure polymer regions can be produced in-situ in a controllable way, as shown in FIG. 1 (a). If irradiation is employed using an interference field or lithographic method (amplitude mask), and if the parameters are selected such that the areas of polymer and of LC (mixture) are pure or almost pure, this periodical difference in composition of the material, its density (and thus refractive index of the material of the film) ensure the formation of a phase hologram (grating). This can be obtained by irradiation with a proper intensity distribution of the actinic light in the interference field or by the mask in such a way that the LC areas or regions are obtained in a shape forming well aligned “fringes”, divided by likewise formed polymer “fringes”, resulting in non-scattering, anisotropic areas. The proper adjustment of the exposure intensity ensures the formation of the mentioned lined structure. Under the application of the external electrical, electromagnetic or magnetic field, the grating can then be switched from the diffraction to the non-diffraction state, due to the matching between the refractive index of LC and polymer FIG. (1b).

No specific measures during irradiation are required. Normal room conditions, e.g. ambient temperature and pressure are sufficient. Proper exposure intensity allows controlling the rate of the monomer photopolymerization such that the diffusion of LC molecules or components is not prohibited or hindered in any moment of time. Low-rate diffusion of LC ensures the formation of the continuous LC structures, e.g. lines, fringes or the like.

The exposure intensity itself can be properly selected by a skilled artisan in the light of the physical properties of the selected chemical components. Specifically, the ratio of the polymerization rate to the diffusion rate is important to allow sufficient time for the smaller molecules and especially the LC molecules to escape from the forming polymer network. Clearly, the polymerization rate can be controlled by means explained above. Diffusion rate is determined by the diffusion coefficients of the smaller sized components, mainly LC molecules, which inter alia are dependent on the diameter and shape of the molecules, their hydrophilic/hydrophobic properties relative to that of the growing polymer network. Thus, for each mixture, the respective parameters will be individually selected as known in the art. Reference is made to relevant articles, e.g. J. R. Lawrence, F. T. O'Neil, J. T. Sheridan, Optik 112 (2001) 449, G. M. Karpov, V. V. Obukhovsky, T .N. Smirnova, V. V. Lemeshko Spatial transfer of matter as a method of holographic recording in photoformers Opt. Comm. 174 (2000) 391-400), or Smirnova T. N., Sakhno O. V. Kinetic peculiarities of holographic recording in photopolymers 1 Proc. SPIE, 1998, V. 3488, PP. 276-284.

Efficiency of the grating (refractive index modulation) or volume periodic structures is increased with the growth of the segregation of polymer and LCs, which is determined by their thermodynamic compatibility and kinetic parameters of the polymerization process and diffusion segregation of the components. The diffusion process will not limit the rate of the hologram recording, which (in such mixtures) is determined by the rate of polymerization.

The intensity of the illuminating light should be sufficiently low to provide a not very fast crosslinking of monomers in bright regions and to allow a maximal segregation of LCs from these areas. On the other hand, upon low illumination intensity (which gives a low relative contrast of the illumination pattern) the rates of polymer conversion into bright and dark regions will become almost equal, which can slow down the rate of diffusion mass-transport and decreases the segregation degree. Moreover, relatively high intensity in the bright regions (and a sufficiently high contrast of the pattern) is required to form a dense polymeric network in the said regions. Besides, the efficiency of the diffusion mass-transport and final grating efficiency is dependent on the period of structure. Thus, all points mentioned above should be taken into account to adjust the illumination conditions.

For example, if the basic mixture contains thiol-ene polymerizable components, an irradiation intensity of from about 0.1 to 200 mW/cm2 with UV actinic light, depending on the concrete material and the efficiency of phase separation, may be used. More preferably, the intensity does not exceed 100-150 mW/cm² and is even more preferably in the range of about 20 to 50 mW/cm².

If the intensity of irradiation exceeds an upper limit beyond which the polymerization rate is too high to allow monomers to sufficiently diffuse from the growing polymer network, the formation of PDLC structures are observed. These PDLCs are characterized by much stronger light-scattering and by the absence of anisotropy after the fabrication step.

The resulting polymer-LC material has a spatial distribution of LC (with a non-droplets morphology) within the photochemically cured polymer matrix. Due to the almost uniform LC director's alignment within the LC-rich planes of POLIPHEM, that takes place during the exposure, these structures are polarization dependent and hence the POLIPHEM reveals the anisotropy after the exposure step, in contrast to the usual (H)PDLC. Microscopic images of POLIPHEM gratings with Λ=1.2 μm and 0.85 μm, d=8 μm and part of Fresnel lens based on POLIPHEM (with a distance between fringes near 6 μm) between crossed polarizers are shown in FIG. 2.

Evidence of the non-droplets morphology of LC inside the LC-rich regions of POLIPHEM can be given by the observation of the relief structure of POLIPHEM layers after the removal of one substrate. FIG. 3 presents the AFM picture of such treated grating with Λ=1.2 μm, d=14 μm, The depth of the surface relief h is up to 120 nm and more.

Formation of POLIPHEM can be controlled by observing the shape of the kinetic curve during irradiation (through a mask or by holographic recording) One example of such a curve is given in FIG. 4a. Usually non-actinic light in real time is used for this observation, for example, the beam of a He-Ne laser. This beam penetrates into the recording layer under the corresponding Bragg angle (adjusted for the used period of structure). A two-stages curve shows the presence of two coexisting processes—the first corresponds to the formation of a phase grating (at the level of diffraction efficiency near 30%) probably due to a fast photopolymerization of monomer/oligomer in the bright regions of the light periodic field (I stage). The second process corresponds to the increase of the refractive index modulation of grating (and diffraction efficiency) due to the irreversible diffusion of LC into the regions of low photopolymerization (II stage). Final diffraction efficiency of gratings can be high (up to 98% at λ=632.8 nm for p-polarized light). When such specific kinetic curve cannot be observed, formation of POLIPHEM usually does not take place.

In the diffracted state (“off-state”), an electric field can be applied to the POLIPHEM structure which is able to change the final orientation of LC director in the LC regions therein which causes the refractive index modulation of the “fringes” to reduce and then the grating diffraction efficiency to decrease up to very low values (“on-state”) FIG. 5. illustrates that in a POLIPHEM structure, switching between the diffracting state and the transparent state is fast (for about 15-20 μsec.). Maximum obtained contrast ratio between “off-state” and “on-state” is near 300.

In specific cases, POLIPHEM structures may be used as waveguide reflection Bragg gratings. For this purpose, the light should be penetrate into the film though the lateral edge of the POLIPHEM grating. In these cases, POLIPHEM are fabricated as transmission gratings and will act as reflection grating for the light in a waveguide mode propagation. The extremely large spectral shift of the narrow-width selectivity band can be achieved by the application of an electrical field or by temperature processing. The controlled reflectivity and transitions of the light by such type of the optical element could achieved by the following ( see FIG. 6): Light with a spectral width from λ₁ up to λ₂ at the input of the waveguide will be divided into two parts—the first, corresponding to the reject band of the POLIPHEM based waveguide filter, will be reflected back and the second part of the light will pass through the element. With application of the voltage the spectral band will be shifted and, consequently, the spectral range of transmitted and reflected light will be changed, too.

This opens the possibility to use POLIPHEM structures as or within different elements, e.g. for visual displays and optical telecommunication systems like mirrors, line filters, electro-optical switches and like.

Reflective holographic polymer-liquid crystal elements exhibit narrow wavelength bands with high reflection efficiency and can be controlled by the electric fields. Therefore, they are attractive candidates for numerous applications, for example, reflective display. Such switchable reflection HOE can be fabricated on the base of POLIPHEM structures as well, as outlined above. Under application of the field across such reflection grating it can be switched between a state where it is reflective and the state where it is transitive.

In the fabrication of the reflection POLIPHEM, some specific demands should be fulfilled. For example, nematic liquid crystals or liquid crystal mixtures having a negative dielectric anisotropy As must be utilized as LC component in the polymerizable mixture. In reflection structures, the fringes should be placed completely or almost parallel to the substrates, and the director of LC will be align along the gratings vector (which is almost perpendicular to the substrates surfaces in the “off-state”). To control the grating parameters at the electric field application, LC must be rotated perpendicular to the electrical field vector E, then As should be negative. Two-frequency LC can be used for the same aim (LC in which As is changed for different frequencies of the applied voltage).

Switching of the reflective grating in case of a positive anisotropy could be done with magnetic filed.

Numerous different monomers and LCs may be combined in solution and photopolymerized in accordance with the present invention, and the LC concentration within the solution may be varied considerably. Several specific examples will now be described, and these examples are intended to illustrate various implementations of the invention, and are not intended to be limiting.

Using the method of the present invention, e.g. the following subject-matter can be provided:
a) Rigid or flexible films, having first areas being composed of photocured polymer and second areas being solely, substantially or mainly composed of liquid crystals or a liquid crystal mixture, wherein (a) the first and second areas alternate in at least a first plane, while the composition of the film is substantially invariable in at least one direction which is angular to the said first plane, or that (b) at least one of either the first or the second areas is completely surrounded by the other area and the said areas are located in a periodic pattern.
b) Films as defined under a), wherein in alternative (a), the first and second areas do not alternate in a second direction perpendicular to said first plane.
c) Films as defined under a) or b), wherein in alternative (a), the first and second areas either extend from one surface of the film to the opposite surface, or are layers extending along the film plane.
d) Films as defined under a) to c), wherein the first and second areas constitute spatially periodic structures, preferably straight or curved fringes.
e) Films as defined under a) to d), wherein the film has a thickness of about 1-100 μm, preferably 4 to 50 μm and more preferably 5 to 25 μm.
f) Optical elements, comprising a film as defined under a) to e) disposed on a flat, light transmitting substrate or beween two flat substrates at least on of which is light transmitting.
g) Optical elements as defined under f), wherein the first and the second substrate are provided with means for application of an electrical, magnetic or electromagnetic field therebetween.
h) Optical elements as defined under g), wherein the means for generating an electrical field includes a conducting film covering at least part of the inside of the substrates.
i) Optical elements as defined under f) to h), wherein the optical element is a diffractive element selected from elements having 2D geometry wherein areas the composition of which is substantially invariable extend either from one surface of the film to the opposite surface, or wherein the film consists of layers the composition of which is substantially invariable and which extend along the film plane, and elements having 3D geometry, at least one of either the first or the second areas is completely surrounded by the other area.
j) Optical elements as defined under l), wherein areas of the element having 2D geometry the composition of which is substantially invariable extend in a perpendicular or tilted angle in relation to the surface of the film.
k) Optical elements as defined under g) to j), wherein the first areas are characterized by an optical dielectric constant with a value that remains substantially constant if an electric, magnetic or electromagnetic field is applied thereon.
l) Optical elements as defined under f) to k), wherein the second areas are characterized by optical birefringence which varies under the influence of an electric, magnetic or electromagnetic field.
m) Optical elements as defined under f) to l), wherein the distance of the center of the first area to the center of the second area is in the range of about 150 nm to 10 μ.

Further, the optical elements as defined under f) to m) can be operated or used, wherein the operation or use comprises orientation and/or reorientation of the liquid crystals in the second areas by application of an electric, electromagnetic or magnetic field such that the element may be switched between a diffracted state (off state) and a non-diffracted state and optionally any intermediate state between said states which intermediate states vary in refractive index of the second areas. This can e.g. be in an optical telecommunication device, wherein the optical element is preferably selected from bi-directional electro-optical switches, variable optical attenuators (VOAs), tunable Bragg grating filters (TBG filters), wavelenght division multiplexers, which can be realized either in free-space or planar waveguide architecture, switchable beam-steering devices for freespace optical coupling or other purposes, tuneable spectral filters and waveguide systems.

### EXAMPLE 1 (Comparative Example)

Samples of photopolymerizable mixture were fabricated using NOA®68 optical adhesive produced by Norland Products, Inc., New Brunswick, N.J., and 5CB (Merck) cyanobiphenyl liquid crystal mixture in a 60:40 ratio, by weight. Surfactant FC-431 2 wt. % and UV photoinitiator Irgacure®369 (Ciba) 0.5% were added. All components were thoroughly mixed and then used for drop filling between ITO (indium-tin oxide) coated glass substrates with 8-15 μm Mylar.RTM spacers. All operations were made at room temperature. The cells filled with isotropic liquid were exposed to an interference field of 365 nm Ar-laser wavelength with vertical (s-) polarization of the recording beams. The exposure time was varied in the range 100-300 sec, and the intensity of the curing laser light (for both beams) was in the range 200-250 mW/cm². Volume transmission gratings with periods 1.5-0.3 μm were recorded in the test cells at 22° C. (room temperature). Real-time behaviour of the grating's diffraction efficiency (kinetic of holographic recording) was tested by Ne-He laser beam with horizontal (p-) and/or vertical (s-) polarization, which was input into the cell at the appropriate Bragg angle. Diffraction efficiency (DE) is determined as a ratio of the intensity of the diffracted beam to a sum of the diffracted and transmitted ones. Under the mentioned recording conditions the common holographic PDLC structures (prior art) were produced. This was proven by the presence of a light scattering in the samples which is due to LC droplet formation of the samples as described above, by the absence of anisotropy after holographic recording, and a rather low diffraction efficiency, not more than 60%.

### EXAMPLE 2

Reactive mixture and samples were fabricated as for Example 1. The cells filled with isotropic liquid were exposed to the interference field with wavelength 365 nm and s-polarization of the recording beams to record the transmission gratings with periods 1.5-0.3 μm at 22° C. The total intensity of the laser light (for both beams) was varied in the range 40÷60 mW/cm². As an example, kinetic curve of the holographic recording of grating with Λ=0.9 μm, d=8 μm is shown at FIG. 4.a; it has a two-stages behavior: the first stage is due to polymerization process and the second one is due to a phase separation process. As result, the POLIPHEM structure was created. DE was near 98% (on 632.8 nm for p-polarization of the tested beam). Almost full absence of the light-scattering and high anisotropy of the grating after the holographic exposure was observed. The electro-optical properties (dependence of DE via applied electric field) of such structures are shown on the FIG. 5, curve 1.

### EXAMPLE 3

Reactive mixture and samples were fabricated as for Example 1,2. Volume transmission gratings with periods of 1.2-0.5 μm were recorded at 22° C. The cells were placed into the interference field with wavelength 365 nm. The used light intensity was varied in the range 60÷100 mW/cm². Kinetics of the holographic recording is shown at FIG. 4b (Λ=0.9 μm, d=8 μm). It has three-stages behavior: the first stage is due to the polymerization process and the second one due to phase separation processes. The third stage shows a decrease of the diffraction efficiency due to over-modulation of the grating. In this case, POLIPHEM system was created also. DE of the transmission volume grating is the sinus function of the thickness d multiplied on the refractive index modulation, Δn. If DE reaches 100% (on 632.8 nm p-polarization of tested beam) and then falls up to proper value (over-modulation), it means that the refractive index modulation (Δn) of the grating rises. Then Δn of the grating from Sample 3 is higher than for Sample 2. This Sample was characterized by almost full absence of light-scattering and anisotropy after holographic recording. The electro-optical response is shown on the FIG. 5, curve 2. The difference from the Example 2 that is the switching curve has two inflections during the increase of the applied voltage. It can be explained by the specific alignment of LC in the over-modulated grating.

WHAT IS CLAIMED IS:

1-20. (canceled)

21. A method for the production of a rigid or flexible film, having first areas being solely, substantially or mainly composed of photocured polymer and second areas being solely, substantially or mainly composed of liquid crystals or a liquid crystal mixture wherein, according to alternative (a), the first and second areas alternate in at least a first plane, while the composition of the film is substantially invariable in at least one direction that is angular to the said first plane, or, according to alternative (b), at least one of either the first or the second areas is completely surrounded by the other area, respectively, and the first and second areas are located in a periodic pattern; or for the production of an optical element comprising said film disposed on a flat, light transmitting substrate or between two flat substrates, wherein at least one of the two substrates is light transmitting; the method comprising the steps of:
(a) providing a homogeneous and isotropic mixture, comprising at least a first component, consisting of one or more photocurable monomers and/or oligomers, and a second component, consisting of one or more liquid crystals or a liquid crystal mixture, and optionally further comprising a photoinitiator for photopolymerization of the photocurable monomers and/or oligomers, wherein said homogeneous and isotropic mixture is homogeneous and optically clear within a temperature range of at least between 20° C. to 25° C., more preferably of at least between 15° C. and 25° C.,
(b) preparing an optically transparent film of said homogeneous and isotropic mixture on a substrate or filling said homogeneous and isotropic mixture into a space between two substrates, wherein at least one of the two substrates is actinic light transmitting, wherein step (b) is performed within the same temperature range as defined in step (a),
(c) irradiating at least one surface of the optically transparent film of step b) with an inhomogeneous light field of actinic light such that areas of the film are irradiated while others are not or substantially not irradiated, said step of irradiating being performed within the temperature range as defined in step (a) and having an intensity sufficiently low that the first areas being solely, substantially or mainly composed of photocured polymer are formed, while the liquid crystal or liquid crystal mixture components completely, substantially or mainly escape into the second areas which are not or substantially not irradiated, whereby said rigid or flexible film is formed, and
(d) removing one or both of the two substrates depending on whether said rigid or flexible film is to be prepared alone or said rigid or flexible film is to be prepared on one of the two substrates.

22. The method according to claim 21, wherein in said rigid or flexible film prepared according to the alternative (a) the first and second areas do not alternate in a second direction perpendicular to said first plane.

23. The method according to claim 21, wherein in said rigid or flexible film prepared according to alternative (b) the first and second areas either extend from one surface of said rigid or flexible film to the opposite surface or the first and second areas are layers extending along a film plane of said rigid or flexible film.

24. The method according to claim 21, wherein in said rigid or flexible film the first and second areas constitute spatially periodic structures, preferably straight or curved fringes.

25. The method according to claim 21, wherein the optically transparent film of step b) has a thickness of about 1 μm to 100 μm, preferably 4 μm to 50 μm and more preferably 5 μm to 25 μm.

26. The method according to claim 21 for the preparation of an optical element, wherein the two substrates are provided with means for application of an electrical field, a magnetic field or an electromagnetic field therebetween.

27. The method according to claim 26, wherein the means for application of an electrical field includes a conducting film covering at least part of the inside of the two substrates.

28. The method according to claim 26, wherein the optical element is a diffractive element selected from elements having 2D geometry, wherein the first and second areas when said rigid or flexible film has a composition that is substantially invariable extend either from one surface of said rigid or flexible film to the opposite surface, or wherein said rigid or flexible film consists of layers extending along a film plane of said rigid or flexible film and has a composition that is substantially invariable, and elements having 3D geometry, wherein at least one of the first and the second areas is completely surrounded by the other area.

29. The method according to claim 28, wherein the first and second areas of the element having 2D geometry when said rigid or flexible film has a composition that is substantially invariable extend perpendicular to or tilted to the surfaces of said rigid or flexible film.

30. The method according to claim 26, wherein the first areas are characterized by an optical dielectric constant with a value that remains substantially constant when an electric field, a magnetic field or an electromagnetic field is applied thereon.

31. The method according to 26, wherein the second areas are characterized by optical birefringence which varies under the influence of an electric field, a magnetic field or an electromagnetic field.

32. The method according to claim 26, wherein a distance of a center of the first areas to a center of the second areas, respectively, is in the range of about 150 nm to 10 μm.

33. The method according to claim 21, wherein said homogeneous and isotropic mixture further comprises a surfactant.

34. The method according to claim 21, wherein said first component of the homogeneous and isotropic mixture is selected from one or more compounds of the group consisting of unsaturated monomers and oligomers, preferably of monomers and oligomers that capable of undergoing a Michael addition, more preferably a combination of thiol-compounds and compounds containing at least one C═C bond that are capable of reacting in a thiol-ene reaction, or a combination of such monomers or oligomers and at least one epoxy compound, even more preferably a combination of at least one thiol compound and at least one monomer or oligomer capable of undergoing a Michael addition.

35. The method according to claim 21, wherein said second component of the homogeneous and isotropic mixture is selected from the group of nematic, smectic and cholesteric liquid crystals and liquid crystal mixtures, optionally doted with dye molecules or photochromic molecules, the liquid crystals having a negative or a positive dielectric anisotropy Δε, wherein nematic liquid crystals or crystal mixtures consisting of or containing nematic liquid crystals are preferred.

36. The method according to claim 21, wherein both surfaces of the optically transparent film are irradiated.

37. The method according to claim 21, wherein the step of irradiating is performed with a periodic or non-periodic light field.

38. The method according to claim 21, wherein the inhomogeneous light field of the step (c) is obtained by irradiation with at least two monochromatic, coherent beams of actinic light that are angular to each other such that an interference pattern is recorded in the volume of the film (holographic recording).

39. The method according to claim 20, wherein the inhomogeneous light field is obtained using a lithographic method, preferably a mask.

40. The method according to claim 21, wherein the irradiation intensity in the step c) is in the range of 0.1 to about 200 mW/cm², and preferably does not exceed 140 W/cm².
